(19) United States
(12) Patent Application Publication
(10) Pub. No.: US 2011/0266289 A1
(43) Pub. Date: Nov. 3, 2011

(54) LINED STORAGE TANK

(76) Inventors: Tony Riviezzo, Granger, IN (US); Todd Outman, Schoolcraft, MI (US)

(21) Appl. No.: 13/096,201

(22) Filed: Apr. 28, 2011

Related U.S. Application Data
(60) Provisional application No. 61/343,390, filed on Apr. 28, 2010.
(60) Provisional application No. 61/380,828, filed on Sep. 8, 2010.

(51) Int. Cl. B65D 6/28; B23P 25/00; B05D 7/16

(52) U.S. Cl. 220/626; 29/527.1

(57) ABSTRACT

The storage tank of the present invention is a two part tank. The exterior or outer container of the storage tank is made of metal, either ferrous or non-ferrous materials, such as for example, aluminum, steel, etc. The interior of the outer container of the storage tank is lined or coated with a plastic material, such as for example, polyethylene, high density polyethylene, cross-linked polyethylene, etc. Retention members protrude from the interior of the outer container to retain the plastic liner within the storage tank. Fixtures are also provided to allow for the connection of attachments to the storage tank.

### RELATED APPLICATIONS

This application claims the benefit of U.S. Provisional Patent Application Ser. No. 61/343,390 for a LINED FUEL TANK TO PREVENT FUEL PERMEATION, filed on Apr. 28, 2010, and U.S. Provisional Patent Application Ser. No. 61/380,828 for a LINED STORAGE TANK filed on Sep. 17, 2010, which are hereby incorporated by reference in its entirety.

### STATEMENT REGARDING FEDERALLY SPONSORED RESEARCH

None

### TECHNICAL FIELD

This invention generally relates to storage tanks and, more particularly, to storage tanks which are resistant to permeation, impact and corrosion.

### BACKGROUND OF THE INVENTION

Metal or plastic storage tanks have traditionally been used to store fuel, chemicals, waste, etc. For example, metal storage tanks have been used underground to store fuel and above ground to store fuel, oil, etc. Plastic fuel tanks have been used, for example, to store chemicals, fuel, etc. By way of example, plastic fuel tanks have been used in recreational vehicles, particularly marine vehicles, lawn and garden vehicles, industrial equipment, etc.

One known problem with metal fuel tanks is corrosion. A known problem with typical plastic fuel tanks is that they permeate fuel vapors, which has become an environmental issue. Another problem with plastic fuel tanks is that they are susceptible to bursting in the event they are accidentally impacted. Due to these concerns, new regulations have been promulgated, which require fuel tanks, particularly those used in marine vehicles to pass permeation and burst tests.

Another issue with existing fuel tanks is the need to be able to use new fuels, such as for example E85.

It is known to coat metal tanks with plastic. However, the plastic that is used is specially formulated and very expensive. An example of such a specially formulated plastic is MICROTHENE MR SP010 manufactured by Equistar and sold by Donnelly Bros. Inc. Microthene MR SP010 is a modified thermoplastic polyethylene-based rotolining and powder coating resin.

Microthene has excellent adhesion to metals and polymers and is used to coat pipes, drums, hollow vessels etc. However, this material is very expensive, as much as 10 times more expensive than standard more generic plastic material. Microthene is not acceptable for use in non-specialized applications, such as marine fuel tanks, industrial vehicle applications, industrial equipment, etc. because of the cost.

### SUMMARY OF THE INVENTION

In general terms, this invention provides a storage tank which prevents undesirable fuel permeation and can pass or even surpass fuel permeation test requirements, burst test requirements promulgated by regulatory authorities, and is resistant to corrosion. Still further, the storage tank of the present invention can be manufactured economically since it can be made with standard low cost plastic which greatly reduces the cost of the lined tank when compared to products using specially formulated materials such as for example Microthene MR SP010.

The storage tank of the present invention is a two part tank. The exterior or outer container of the storage tank is made of metal, either ferrous or non-ferrous materials, such as for example, aluminum, steel, etc. The interior of the outer container of the storage tank is lined or coated with a plastic material, such as for example, polyethylene, high density polyethylene, cross-linked polyethylene, etc.

The exterior or outer container of the storage tank is made by known storage tank manufacturing processes, such as for example pre-forming various sections of the storage tank and welding the sections together to form a unitary tank. Plastic is then inserted into the unitary tank, and rotary molded to coat the entire interior of the tank.

In the disclosed embodiment of the present invention, retention and/or stiffening members are formed or attached to the interior of the metal container, when the container is fabricated. These members add strength to the storage tank, and also provide support to lock the plastic to the metal outer container. The members and the plastic interact to form a mechanical bond of the plastic to the member and through the member to the tank.

In the disclosed embodiment, the retention stiffening members are elongated angle members with a plurality of holes into which plastic can flow during the rotary molding process. Alternatively, or in addition to the retention stiffening members of the disclosed embodiment, retention lugs can be used. The retention lugs have head portions around which the plastic can flow and envelop for retention of the plastic within the metal portion of the fuel tank. In a still further embodiment, the plastic retention members can take the form of rings attached to the tank, such as for example I-bolts mounted into threaded openings or metal loops welded or otherwise attached to the tank. It should be understood by those of ordinary skill in the art that other types of plastic retention members could be used so long as the member can retain the plastic within the tank.

In a further embodiment of the present invention, the interior walls of the metal exterior container are sanded or surface ground to roughen the surface to enhance adhesion of the plastic material to the interior wall of the exterior container. In the preferred embodiment, the process of sanding or surface grinding is done with 36 grit sandpaper, sandblasting or a

Another feature of the storage tank of the present invention is the use of mounting fixtures which are adapted to receive various attachments useful on storage tanks. These attachments can be, for example, fuel level indicators, fuel pump lines, etc. The mounting fixtures of the present invention have circumferential recesses defined by the fixture for receipt of plastic to ensure a fluid tight fit between the fixture and the plastic.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of the storage tank of the present invention;

FIG. 2 is a partial perspective view of the storage tank of the present invention;

FIG. 3 is a partial perspective view of the storage tank of the present invention;

FIG. 4 is a partial perspective view of the storage tank of the present invention;

FIG. 5 is a perspective view of a mounting fixture of the present invention;

FIG. 5A is a cutaway view of the mounting fixture of FIG. 5;

FIG. 6 is a front view of the top stiffening member of the present invention;

FIGS. 6A is a front view of the end stiffening member of the present invention;

FIG. 7 is a perspective view of the top stiffening member of the present invention;

FIG. 7A is a perspective view of the end stiffening member of the present invention; and

FIG. 8 is an exaggerated cutaway view of the storage tank of the present invention illustrating the exterior tank and the plastic layer or

### DETAILED DESCRIPTION OF A PREFERRED EMBODIMENT

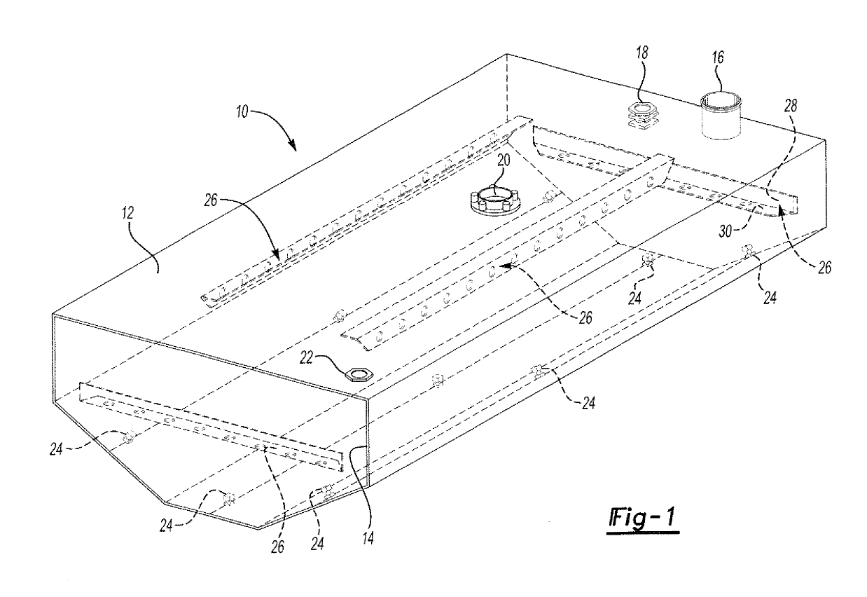

The storage tank of the present invention is generally shown at 10 in FIG. 1. The storage tank 10 of the present invention is a two part storage tank. The exterior 12 of the storage tank is made of metal, either ferrous or non-ferrous materials, such as for example, aluminum, steel, etc. The interior 14 of the storage tank 10 is lined or coated with a standard generic plastic material, such as for example, polyethylene, high density polyethylene, cross-linked polyethylene, etc. See FIG. 8 for an exaggerated view of the exterior 12 and interior 14 of the storage tank 10. The thickness of the wall of the exterior 12 and interior 14 of the storage tank 10 will depend upon many factors including the size of the tank, substance to be stored, etc. The storage tank 10 of the present invention will have very little if any permeation, is corrosion resistant and is impact resistant. The tank 10 is also suitable for all fuel grades including E85. A fill neck 15 is illustrated for filling the tank 10 with material to be stored, such as fuel, chemicals, etc.

The exterior 12 of the storage tank is made by known storage tank manufacturing processes, such as for example by forming various sections of the storage tank and welding the sections together to form a unitary tank, or by casting the exterior or a combination of these methods or other known methods of manufacture.

The interior 14 of the tank is formed by inserting plastic into the unitary tank, and rotational molding the plastic to coat the entire interior of the tank. In one embodiment, the exterior tank 12 acts as the rotary mold. The exterior tank 12 can be heated to temperatures sufficient to melt the inserted plastic material and rotated to ensure that the inserted plastic material covers the entire interior of the tank 12 to form the interior layer or liner 14. In another embodiment, the exterior tank 12 is inserted into a traditional rotational mold which then heats the tank to melt the plastic and is rotated to cover the interior of the exterior storage tank 12 with plastic to form the interior layer or liner 14.

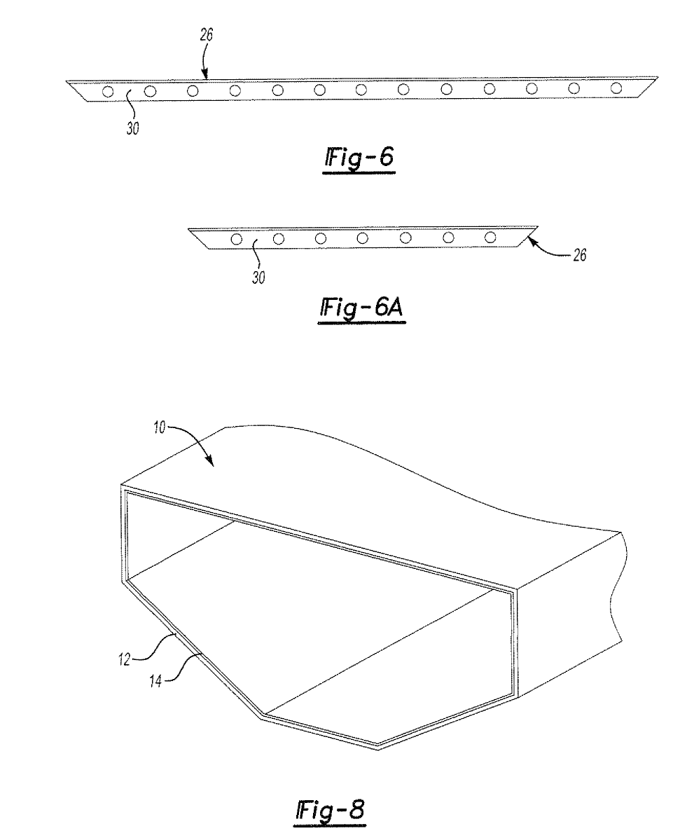

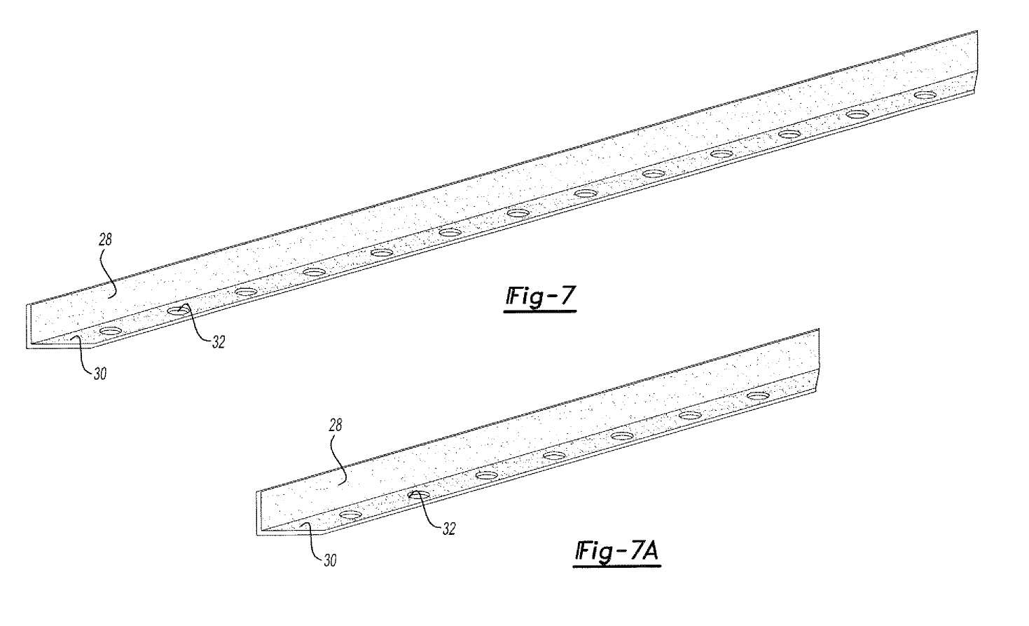

In the disclosed embodiment of the present invention, retention stiffening members 26 are formed or attached to the interior wall of the exterior tank 12, when the exterior tank 12 is fabricated. In the disclosed embodiment of FIGS. 6, 6A, 7 and 7A, the members 26 are illustrated as angled metal with a plurality of holes 32 along one side of the angle and an uninterrupted surface along the other side of the angled metal. It should also be appreciated that the members 26 could have holes in both sides of the angle as well if desired. The uninterrupted surface, or if desired interrupted surface, is fixed to the interior wall of the exterior storage tank 12. It should be appreciated by those of ordinary skill in the art that the exterior storage tank could be formed with unitary retention stiffening surfaces, as opposed to the members being welded or attached in other known ways to the interior wall of the exterior storage tank 12. Additionally, members 26 may also be made of material other than metal, such as carbon reinforced fiber.

These retention stiffening members 26 add stiffness to the storage tank, provide support to lock the plastic layer or liner 14 to the exterior tank 12 and resist shrinkage of the plastic layer or liner 14 when it cools during the application process. The plurality of holes 32 allows plastic to flow into the openings during the rotary molding process. In the disclosed embodiment, the plastic liner 14 covers the retention stiffening members 26 and interlocks within the holes 32. In the disclosed embodiment, there are both upper members and end members. It should be appreciated by those of ordinary skill in the art that any number of members 26 could be employed at various strategic locations within the storage tank 10 and the members 26 could have various shapes and sizes as desired for optimal stiffness of the storage tank 10 and locking of the plastic liner 14 within the exterior storage tank 12.

In a further embodiment of the present invention, the interior walls of the exterior tank 12 are sanded or surface ground to roughen the surface to enhance adhesion of the plastic material 14 to the interior wall of the exterior storage tank 12. In the preferred embodiment, the process of sanding or surface grinding is performed with 36 grit sandpaper grinding wheels, or sandblasting, etc.

Additionally, in the disclosed embodiment, there are a number of lugs 24 which protrude from the interior wall of the exterior surface 12. As disclosed, each of the disclosed lugs 24 have a neck 27 and head 29 around which the plastic can also flow for retention of the plastic within the exterior tank 12 and resistance to shrinkage. Preferably, the plastic will encapsulate the lug 24. In the disclosed embodiment, a base 31 is fixed to the interior wall of the tank 12. In this embodiment, the lug 24 is a threaded bolt 27, which can be threaded into the base 31. It should be appreciated by those of ordinary skill in the art that the lug 24 could be formed as a unitary member or welded to the interior wall of the exterior tank 12 and could take any number of different shapes, and still perform its intended purpose of facilitating the locking of the plastic layer or liner 14 to the interior wall of the exterior tank 12. For example, the lug 24 could be a ring, such as an I-bolt, a hook, a bead of metal, etc. It should be appreciated by those of ordinary skill in the art that the lugs 24 and the members 26 can be used together or separately.

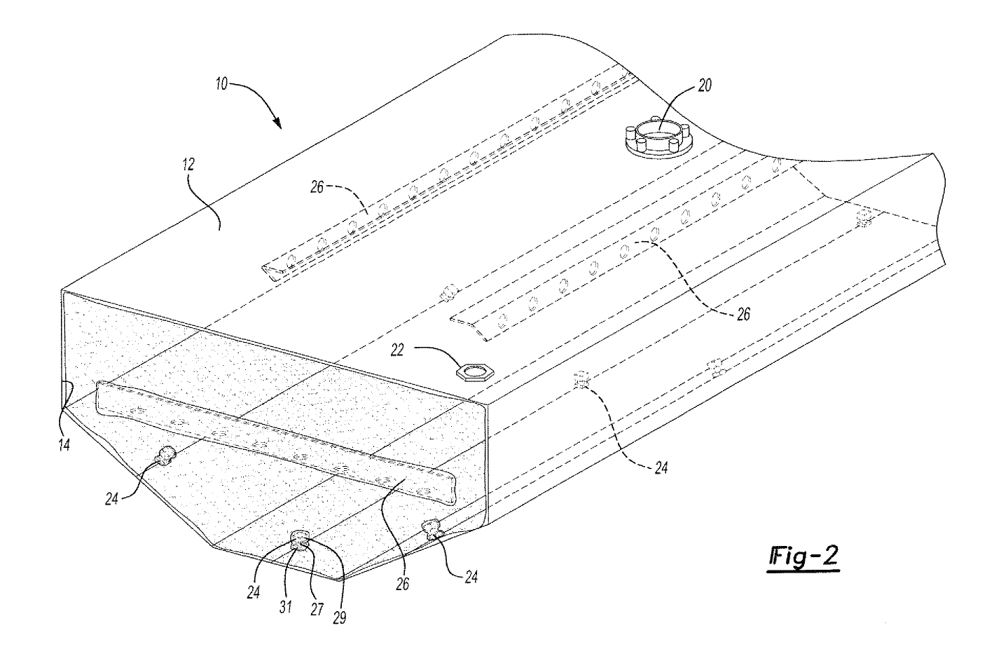

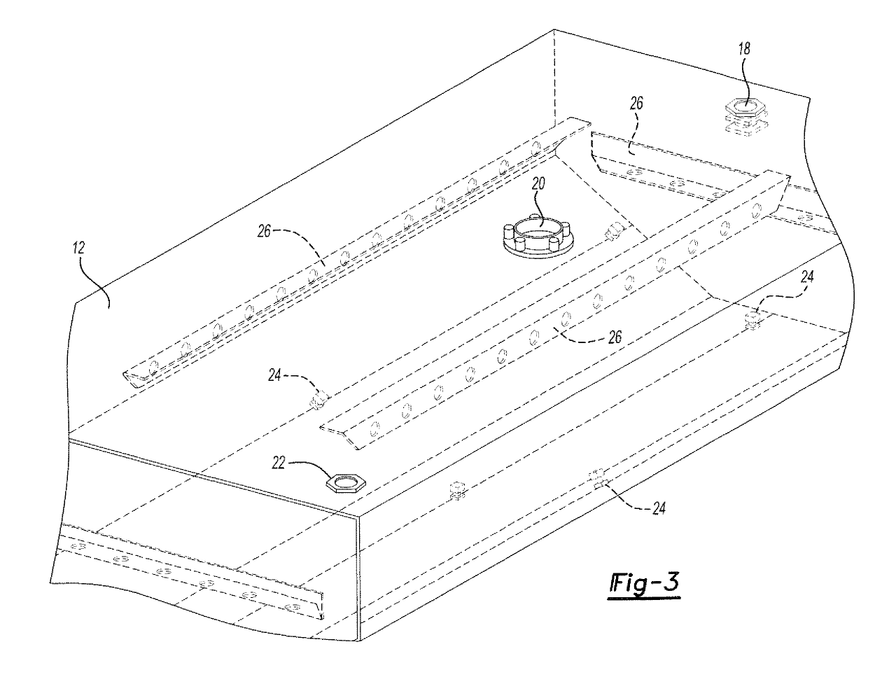

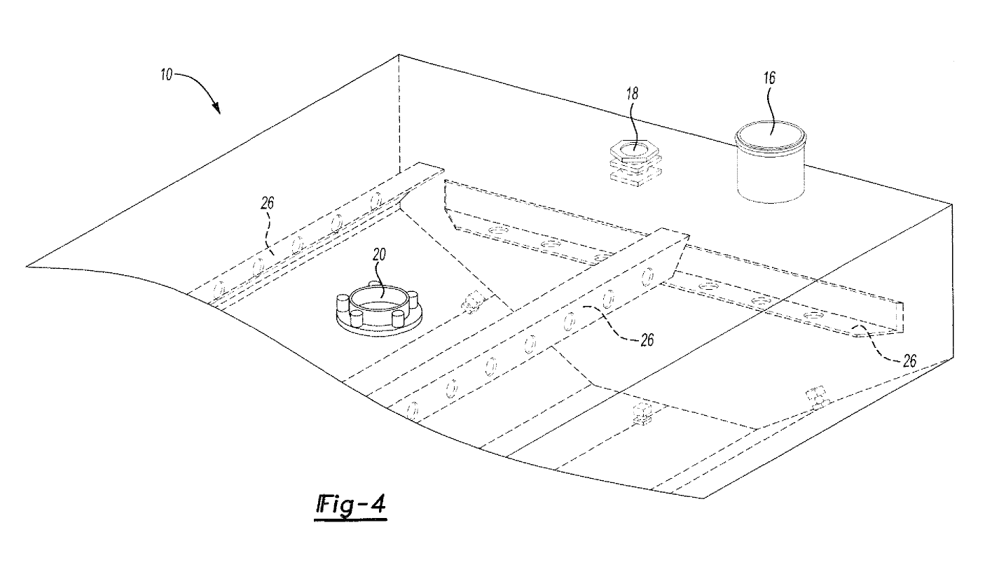

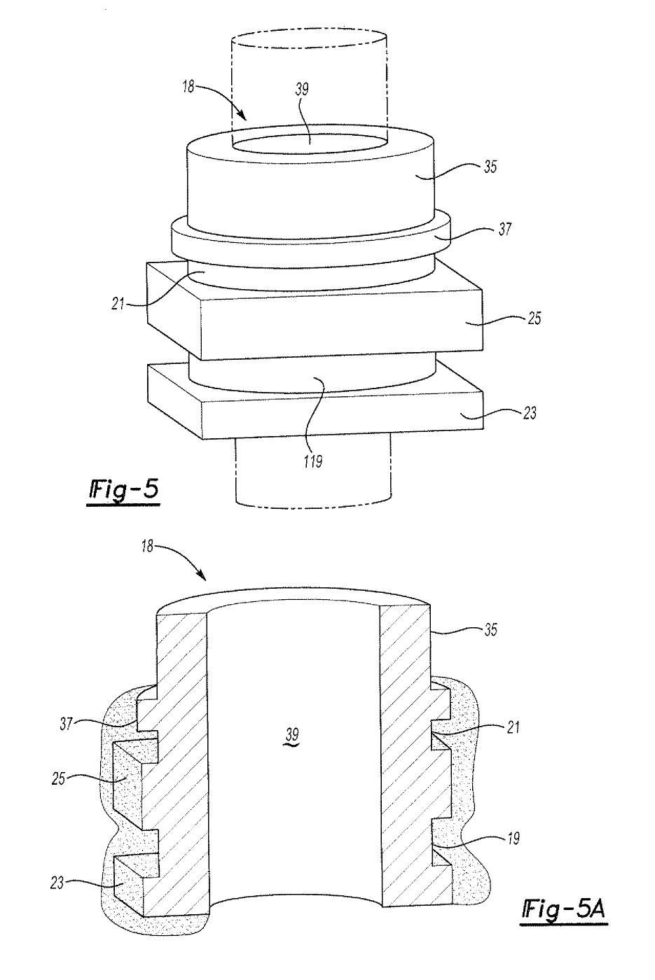

With reference to FIGS. 1 through 4, 5 and 5A, mounting fixtures 18 are illustrated. In the disclosed embodiment, mounting fixtures, 20 and 22 have the same construction as mounting fixture 18. For simplicity, only mounting fixture 18 will be described in detail. The mounting fixtures 18, 20, and 22 are adapted to receive various attachments for use with the storage tank 10. These attachments can be a fuel level indicator, fuel pump and line, vent, sending units, etc. The mounting fixture 18 of the present invention has two circumferential recesses 19 and 21 defined by protruding surfaces 23, 25 and 37. As illustrated, the recesses are circular in cross-section and the protruding surfaces 23 and 25 are square in cross section and the surface 37 is circular in cross section. It should be understood by those of ordinary skill in the art that other shapes could be used, for example, they could all be square, circular, a different combination of square and circular, star shaped, oval, etc.

In use, the fixture 18 is inserted into a mating opening in the exterior tank 12. The protruding surface 37 is abutted against the interior wall of the exterior tank 12. A tool can be used to hold the fixture 18 in place during the rotational molding process. The tool could extend into the opening 39 in the fixture 18 to maintain an opening into the fuel tank 10. As will be appreciated by those of ordinary skill in the art, the opening 39 can be threaded either internally or externally for receipt of a threaded attachment if desired. The threads can also be used to affix the tool. With the fixture 18 held in place, plastic can be rotationally molded into the recesses 21 and 19 and about the protruding surfaces 25 and 23. In this way, the fixture 18 is encapsulated in plastic from the base of protrusion 37 to the base of protrusion 23 and locks into the recesses 19 and 21 to secure the fixture 18 in place and prevent leakage about the fixture 18. As the plastic shrinks during cooling, the fixture 18 is compressed and locked in place.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A storage tank comprising:
an outer container formed of metal, said outer container having an interior surface;
at least one retention member protruding from said interior;
a plastic liner lining said interior surface of said outer container, said plastic liner encompassing said retention member to retain. said plastic liner in said storage tank.

2. The storage tank of claim 1 wherein said plastic liner is formed of polyethylene.

3. The storage tank of claim 1, wherein said plastic liner is formed of high density polyethylene.

4. The storage tank of claim 1, wherein said plastic liner is formed of cross-linked polyethylene.

5. The storage tank of claim I, wherein said retention member is a stiffening member to add strength to the storage tank, and provide support to lock the plastic to the metal tank.

6. The storage tank of claim 5, wherein said retention member further includes a plurality of holes into which said plastic extends into and locks into adjacent plastic for retaining said liner in said storage tank.

7. The storage tank of claim 1, wherein said retention member is at least one lug with a head portion around which the plastic envelops for retention of the plastic within the metal portion of the fuel tank.

8. The storage tank of claim 1, wherein said retention member is at least one ring protruding from said interior of said tank.

9. The storage tank of claim 1, further comprising at least one opening and a fixture mounted into said opening, said fixture having at least two circumferential recesses defined by protruding surfaces, said plastic encompassing said protruding surfaces and extending into said recesses to form a seal about said fixture sealing said fixture with respect to said plastic liner.

10. The storage tank of claim 9, wherein said fixture has three protruding surfaces, one of said surfaces engages said interior of said exterior surface.

11. A method for making a storage tank, said method comprising the steps of:
forming an outer container of metal, said outer container having an interior;
forming at least one retention member protruding from said interior of said outer container;
inserting a plastic material into said interior of said outer container;
applying heat to said outer container to melt said plastic material and allow said plastic material to flow within said outer container;
encompassing said retention member with plastic material to retain said plastic liner in said storage tank.

12. The storage tank of claim 11 wherein said plastic liner is formed of polyethylene.

13. The storage tank of claim 11, wherein said plastic liner is formed of high density polyethylene.

14. The storage tank of claim 11, wherein said plastic liner is formed of cross-linked polyethylene.

15. The storage tank of claim 11, wherein said retention member is a stiffening member to add strength to the storage tank, and provide support to lock the plastic to the metal tank.

16. The storage tank of claim 15, wherein said retention member further includes a plurality of holes, said plastic flows into and through said holes to interlock into adjacent plastic to envelop and retain said liner in said storage tank.

17. The storage tank of claim 11, wherein said retention member is at least one lug with a head portion, said plastic envelops at least said head portion for retention of the plastic within the metal portion of the fuel tank.

18. The storage tank of claim 11, wherein said retention member is at least one ring protruding from said interior of said tank.

19. The storage tank of claim 11, further comprising at least one opening, mounting at least one fixture into said opening, said fixture having at least two circumferential recesses defined by protruding surfaces, flowing said plastic to encompass said protruding surfaces and extend into said recesses to form a seal about said fixture sealing said fixture with respect to said plastic liner.

20. The storage tank of claim 19, wherein said fixture has three protruding surfaces, engaging said interior of said exterior surface with at least one of said protruding surfaces and then flowing said plastic about said other protruding surfaces of said fixture.
